(19) United States
(12) Patent Application Publication
(10) Pub. No.: US 2020/0196042 A1
(43) Pub. Date: Jun. 18, 2020

(54) BLUETOOTH EARPHONE CHARGING DEVICE HAVING NOVEL STRUCTURE

(71) Applicant: XIAMEN PADMATE TECHNOLOGY CO., LTD., Xiamen, Fujian (CN)

(72) Inventor: Xiaolu CAI, Xiamen (CN)

(73) Assignee: Xiamen Padmate Technology Co., Ltd., Xiamen, Fujian (CN)

(21) Appl. No.: 16/619,461

(22) PCT Filed: Feb. 27, 2019
(86) PCT No.: PCT/CN2019/076309

§ 371 Date: Dec. 5, 2019

(30) Foreign Application Priority Data
Apr. 25, 2018 (CN) 201820602296.8

(51) Int. Cl. H04R 1/10

(52) U.S. Cl. CPC H04R 1/1025; H04R 2420/07; H04R 1/1016

(57) ABSTRACT

Disclosed is a Bluetooth earphone charging device having a novel structure, comprising a housing. The housing is provided with two earphone holders for accommodating Bluetooth earphones; a charging interface is provided in the earphone holder; a PCB and a battery are provided in the housing; the battery is connected to the PCB, and the PCB is connected to the charging interface; the outside of the housing is connected to a sleeve in a detachable manner. The Bluetooth earphone charging device of the present invention is simple to use and convenient to carry because during use, Bluetooth earphones can be charged by simply putting the Bluetooth earphones in the earphone holders, where no additional earphone charging connection line is needed.

### BACKGROUND OF THE INVENTION

### 1. Field of the Invention

The present invention relates to a charging device, and more particularly to a Bluetooth earphone charging device having a novel structure.

### 2. Description of the Prior Art

Nowadays, Bluetooth earphones are popular because of portability and ease of use. Although Bluetooth earphones are easy to use and portable, they needs to be charged before the Bluetooth earphones are used in comparison with ordinary earphones with cables.

Most Bluetooth earphones are charged with a charging cable that is connected with the earphones and a power supply, or a charging cable that is connected with earphones and a power bank. In this way, since the additional charging cable and the earphones are independent of the power bank, it is very inconvenient to carry and use.

Accordingly, the inventor of the present invention has devoted himself based on his many years of practical experiences to solve these problems.

### SUMMARY OF THE INVENTION

The primary object of the present invention is to provide a Bluetooth earphone charging device having a novel structure, which is simple to use and convenient to carry.

In order to achieve the above object, the present invention adopts the following technical solutions:

A Bluetooth earphone charging device comprises a housing. The housing is provided with two earphone holders for accommodating Bluetooth earphones. The earphone holders each have a charging interface. A PCB (printed circuit board) and a battery are provided in the housing. The battery is connected to the PCB. The PCB is connected to the charging interface. An outside of the housing is connected to a sleeve in a detachable manner.

The housing includes an upper housing, a lower housing, and two side plates. The upper housing, the lower housing and the two side plates are connected to each other to form an accommodating chamber for accommodating the battery and the PCB.

The earphone holders are disposed on the upper housing, and are formed by recessing the upper housing toward the lower housing.

At least one USB interface is provided on the side plates, and the USB interface is connected to the PCB.

The sleeve includes a main body and a cover that are connected to each other. The main body is detachably connected to an outer side surface of the lower housing. The cover is movable and configured to cover the upper housing.

The main body of the sleeve and the lower housing are connected through an engaging buckle and an engaging hole.

A rigid support member is connected to an inner side surface of the main body of the sleeve. Two sides of the support member are provided with slide rails. Two sides of the lower housing are provided with slide grooves. The main body and the lower housing are connected through the slide rails of the support member to slide into the slide grooves of the lower housing.

The main body of the sleeve and the lower housing are connected through a layer of removable glue.

The main body of the sleeve and the lower housing are connected by a magnetic means or by riveting.

After adopting the above structure, the Bluetooth earphone charging device of the present invention is simple to use and convenient to carry. In use, the Bluetooth earphones are placed in the earphone holders to realize charging of the Bluetooth earphones. There is no need for an additional earphone charging cable. Moreover, when the Bluetooth earphones are not in use, the Bluetooth charging device may serve as a storage box for storing the Bluetooth earphones therein.

Furthermore, the housing of the charging device is protected by the sleeve, and the sleeve is detachably connected to the housing. When the sleeve is damaged, only the sleeve needs to be replaced, without replacing the entire housing or the entire charging device, which reduces the cost greatly. Besides, the user can change the sleeve according to his/her preference, thereby changing the appearance of the charging device and making the appearance of the charging device more diverse.

### BRIEF DESCRIPTION OF THE DRAWINGS

FIG. 1 is a structural schematic view in accordance with a first embodiment of the present invention;

FIG. 2 is a cross-sectional view of FIG. 1;

FIG. 3 is a structural schematic view in accordance with a second embodiment of the present invention;

FIG. 4 is a cross-sectional view of FIG. 3;

FIG. 5 is a structural schematic view in accordance with a third embodiment of the present invention;

FIG. 5A is a partially enlarged view of FIG. 5;

FIG. 6 is a cross-sectional view of FIG. 5;

FIG. 7 is a structural schematic view in accordance with a fourth embodiment of the present invention;

FIG. 8 is a structural schematic view in accordance with a fifth embodiment of the present invention; and

FIG. 9 is a cross-sectional view of FIG. 8.

### DETAILED DESCRIPTION OF THE PREFERRED EMBODIMENTS

Embodiments of the present invention will now be described, by way of example only, with reference to the accompanying drawings.

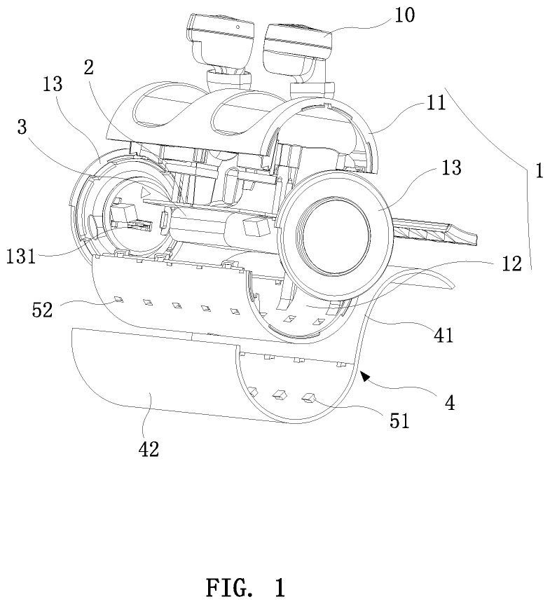

Referring to FIG. 1 through FIG. 9, the present invention discloses a Bluetooth earphone charging device having a novel structure, comprising a housing 1, a PCB (printed circuit board) 2, a battery 3, and a sleeve 4. The housing 1 is provided with two earphone holders 111 for accommodating Bluetooth earphones 10. The PCB 2 and the battery 3 are disposed in the housing 1 for charging the Bluetooth earphones 10. The sleeve 4 is connected to the outside of the housing 1 for protecting the housing 1.

The housing 1 includes an upper housing 11, a lower housing 12, and two side plates 13. The upper housing 11 is connected to the upper end of the lower housing 12. One side plate 13 is connected to one end of the upper housing 11 and the lower housing 12, and the other side plate 13 is connected to the other end of the upper housing 11 and the lower housing 12. The upper housing 11, the lower housing 12 and the two side plates 13 are cooperatively connected to form an accommodating chamber for accommodating the battery 3 and the PCB 2. The upper housing 11 is recessed toward the lower housing 12 to form the two earphone holders 111 for accommodating the Bluetooth earphones 10. The earphone holders 111 each have a charging interface. The charging interface is connected the PCB 2. The PCB 2 is connected to the battery 3.

At least one USB interface 131 is provided on the side plates 13. The USB interface 131 is connected to the PCB 2 for charging the charging device or charging the other device using the charging device.

The sleeve 4 is connected to the outside of the lower housing 12. The sleeve 4 includes a main body 42 and a cover 41 that are connected to each other. The main body 42 is detachably connected to the outer side surface of the lower housing 12. The cover 42 is movable and configured to cover the upper housing 11.

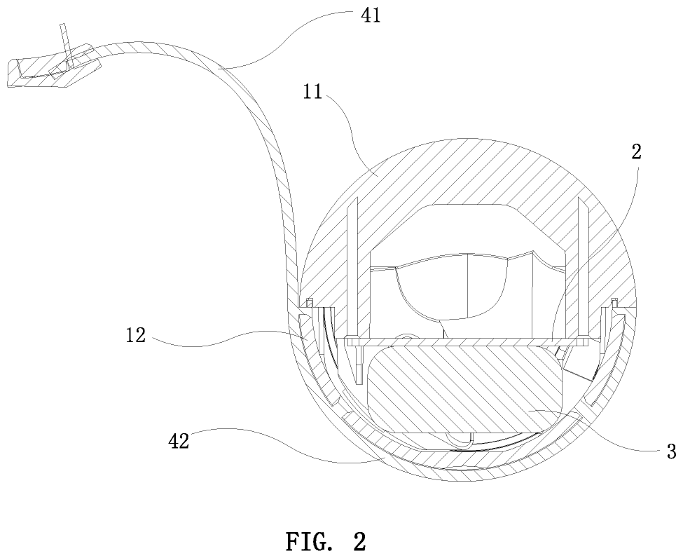

The main body 42 and the lower housing 12 are connected through an engaging buckle 51 and an engaging hole 52. As shown in FIG. 1 and FIG. 2, the inner surface of the main body 42 is provided with an engaging buckle 51 protruding in the direction of the lower housing 12. The outer surface of the lower housing 12 is provided with an engaging hole 52 corresponding to the engaging buckle 51. The main body 42 is pressed for the engaging buckle 51 to be engaged into the engaging hole 52, thereby achieving the connection of the main body 42 and the lower housing 12.

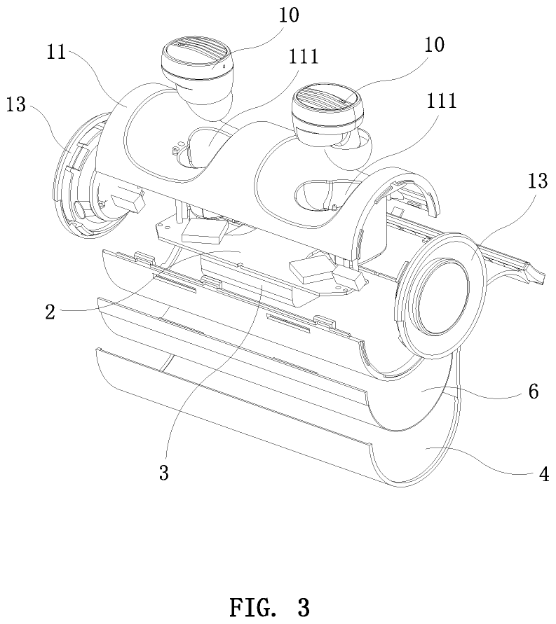

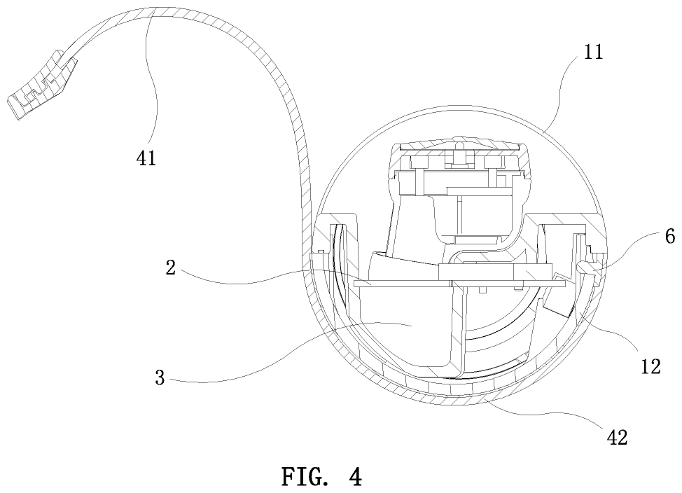

The main body 42 and the lower housing 12 may be connected through a layer of removable glue 6. As shown in FIG. 3 and FIG. 4, the layer of movable glue 6 is sandwiched between the main body 42 and the lower housing 12, thereby achieving the connection of the main body 42 and the lower housing 12.

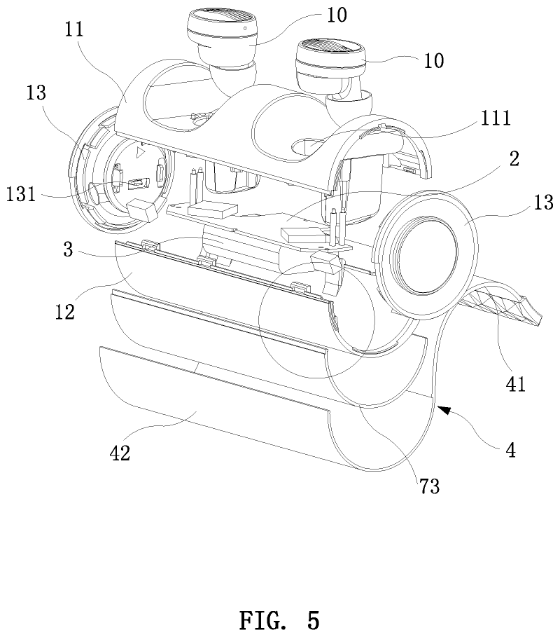

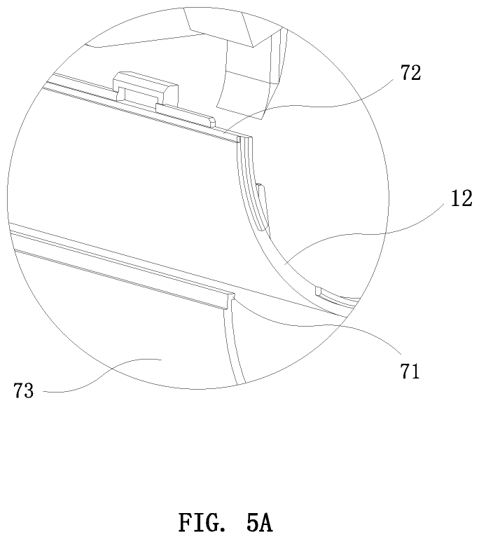

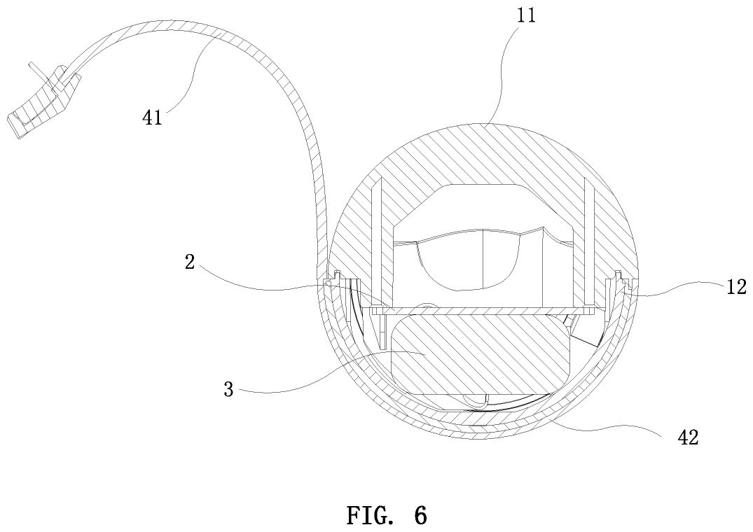

The main body 42 and the lower housing 12 may be connected through a slide groove 72 and a slide rail 71. As shown in FIG. 5 and FIG. 6, a rigid support member 73 is connected to the inner side surface of the main body 42. The support member 73 corresponds in shape to the lower housing 12. Two sides of the support member 73 are provided with slide rails 71. Two sides of the lower housing 12 are provided with slide grooves 72. The slide rails 71 of the support member 73 slide into the slide grooves 72 of the lower housing 12 to realize the connection of the main body 42 and the lower housing 12.

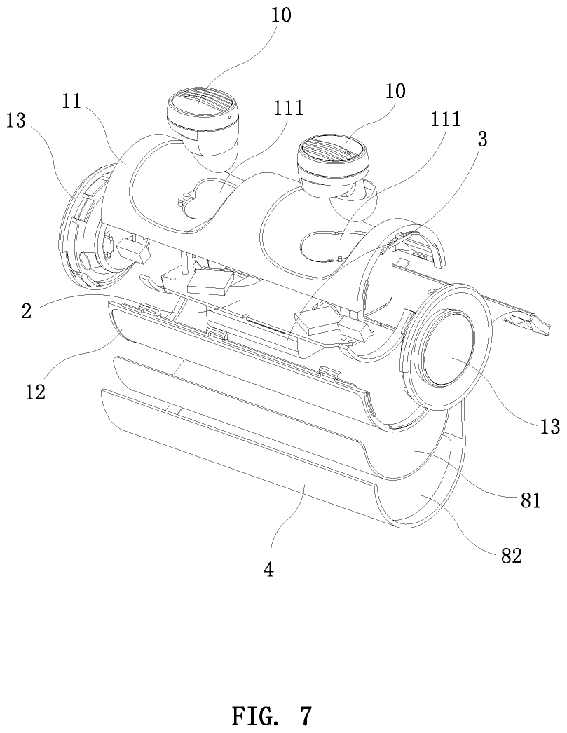

The main body 42 and the lower housing 12 may be connected by a magnetic means. As shown in FIG. 7, a metal sheet 82 is disposed on the inner side surface of the main body 42, and a magnetic layer 81 is disposed on the outer side surface of the lower housing 12. The magnetic layer 81 is configured to attract the metal sheet 82 of the sleeve 4, thereby achieving the connection of the main body 42 and the lower housing 12. The magnetic layer 81 may be disposed on the inner side surface of the main body 42, and the metal sheet 82 may be disposed on the outer side surface of the lower housing 12.

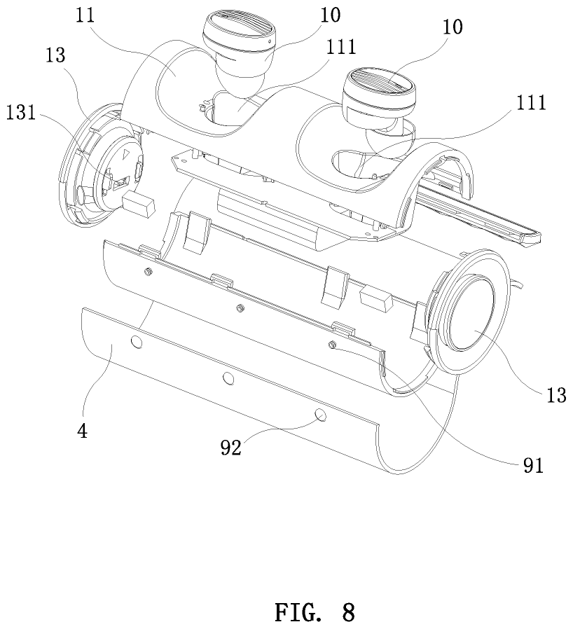

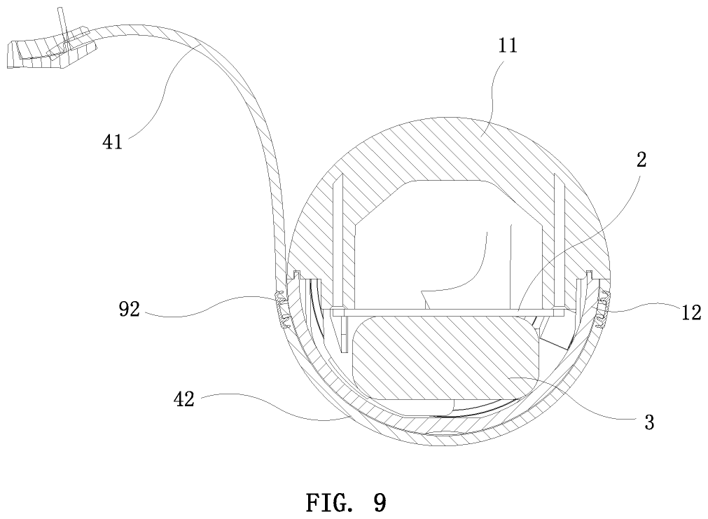

The main body 42 and the lower housing 12 may be connected by riveting. As shown in FIG. 8 and FIG. 9, the outer side surface of the lower housing 12 is provided with rivets 91, and the inner side surface of the main body 42 is provided with rivet clasps 92. The rivets 91 are snapped into the rivet clasps 92 to realize the connection of the lower housing 12 and the main body 42.

When the Bluetooth earphone charging device of the present invention is in use, the cover 41 of the sleeve 4 is opened, and then the Bluetooth earphones 10 are placed in the earphone holders 111 to realize charging of the Bluetooth earphones 10. There is no need for an additional earphone charging cable. It is easy and convenient for use. Moreover, when the Bluetooth earphones 10 are not in use, even if the Bluetooth earphones 10 are fully charged at this time, the Bluetooth charging device may serve as a storage box for storing the Bluetooth earphones 10 therein, so that the user does not need to prepare a storage box for the Bluetooth earphones 10.

Furthermore, the housing 1 of the charging device is protected by the sleeve 4, and the sleeve 4 is detachably connected to the housing 1. When the sleeve 4 is damaged, only the sleeve 4 needs to be replaced, without replacing the entire housing 1 or the entire charging device, which reduces the cost greatly. Besides, the user can change the sleeve 4 according to his/her preference, thereby changing the appearance of the charging device and making the appearance of the charging device more diverse.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A Bluetooth earphone charging device, comprising a housing, the housing being provided with two earphone holders for accommodating Bluetooth earphones, the earphone holders each having a charging interface; a PCB (printed circuit board) and a battery being provided in the housing, the battery being connected to the PCB, the PCB being connected to the charging interface; an outside of the housing being connected to a sleeve in a detachable manner.

2. The Bluetooth earphone charging device as claimed in claim 1, wherein the housing includes an upper housing, a lower housing and two side plates, the upper housing, the lower housing and the two side plates are connected to each other to form an accommodating chamber for accommodating the battery and the PCB.

3. The Bluetooth earphone charging device as claimed in claim 2, wherein the earphone holders are disposed on the upper housing, and are formed by recessing the upper housing toward the lower housing.

4. The Bluetooth earphone charging device as claimed in claim 2, wherein at least one USB interface is provided on the side plates, and the USB interface is connected to the PCB.

5. The Bluetooth earphone charging device as claimed in claim 2, wherein the sleeve includes a main body and a cover that are connected to each other, the main body is detachably connected to an outer side surface of the lower housing, and the cover is movable and configured to cover the upper housing.

6. The Bluetooth earphone charging device as claimed in claim 5, wherein the main body of the sleeve and the lower housing are connected through an engaging buckle and an engaging hole.

7. The Bluetooth earphone charging device as claimed in claim 5, wherein a rigid support member is connected to an inner side surface of the main body of the sleeve, two sides of the support member are provided with slide rails, two sides of the lower housing are provided with slide grooves, the main body and the lower housing are connected through the slide rails of the support member to slide into the slide grooves of the lower housing.

8. The Bluetooth earphone charging device as claimed in claim 5, wherein the main body of the sleeve and the lower housing are connected through a layer of removable glue.

9. The Bluetooth earphone charging device as claimed in claim 5, wherein the main body of the sleeve and the lower housing are connected by a magnetic means or by riveting.
